(19) United States
(12) Patent Application Publication
(10) Pub. No.: US 2026/0263320 A1
(43) Pub. Date: Sep. 10, 2026

(54) A SPA AIR PUMP WITH INFLATING FUNCTION AND A SPA SWIMMING POOL

(71) Applicant: Intex Marketing Ltd., Tortola (VG)

(72) Inventors: Zhi Xiong Huang, Fujian (CN); Ai Ming Tan, Fujian (CN)

(73) Assignee: Intex Marketing Ltd., Tortola (VG)

(21) Appl. No.: 18/873,653

(22) PCT Filed: Jun. 20, 2023
(86) PCT No.: PCT/IB2023/056391

§ 371 Date: Dec. 10, 2024

(30) Foreign Application Priority Data
Jun. 20, 2022 (CN) 202221545835.1

(51) Int. Cl. A61H 33/02; A61H 33/00

(52) U.S. Cl. CPC A61H 33/026; A61H 33/6005; A61H 2201/0103

(57) ABSTRACT

A SPA air pump with an inflating function may include a housing and an air nozzle. The housing may include an air inlet, a first air outlet, a second air outlet, and an air passage. The SPA air pump with an inflating function may provide massaging bubbles to a water cavity of an inflatable product, such as an inflatable pool, and inflate an air cavity of the inflatable product.

### RELATED APPLICATIONS

This application is related to Chinese Application No. CN202221545835.1, filed Jun. 20, 2022, the entire disclosure of which is expressly incorporated herein by reference.

### FIELD OF THE DISCLOSURE

The present disclosure relates to a SPA swimming pool, and in particular to a SPA air pump with an inflating function and a SPA swimming pool.

### BACKGROUND OF THE DISCLOSURE

Swimming pools including a SPA massage function are gradually becoming popular among consumers. In addition to normal swimming pool functions, SPA massage swimming pools can input high-pressure air into the pool through the SPA air pump, thereby achieving a massaging effect on the human body.

The function of the SPA air pump in existing technology is relatively simple. The SPA air pump intakes external air and flushes it into the water creating bubbles that massage the human body.

When the swimming pool is an inflatable product, the user needs to prepare an air pump to inflate the inflatable product. This air pump is in addition to the SPA air pump, which is very inconvenient and requires too many items to prepare.

An improved SPA air pump that can provide massaging bubbles and inflate the swimming pool is desired.

### SUMMARY OF THE DISCLOSURE

The present disclosure provides a SPA air pump with an inflating function.

In one form thereof, the present disclosure provides a SPA air pump with an inflating function comprising a housing and an air nozzle. The housing may comprise an air inlet, a first air outlet configured to be connected to a water cavity of an inflatable product, and a second air outlet configured to inflate an air cavity of the inflatable product. The housing may further comprise an air passage. The first air outlet may be connected to the air passage, and a connection between the second air outlet and the air passage may be provided with a movable sealing valve core. The sealing valve core may abut against an elastic reset member to set the sealing valve core at a first position in which the second air outlet and the air passage are sealed. The air nozzle may be configured to connect the sealing valve core and the air cavity of the inflatable product and may further be configured to push the sealing valve core to a second position in which the second air outlet and the air passage are connected, and to cause the sealing valve core to compress the elastic reset member to accumulate an elastic reset force.

In another form thereof, a side of the sealing valve core facing the air nozzle may have an abutting plate extending towards the air nozzle. The abutting plate may form a connection with the air nozzle.

In another form thereof, the SPA air pump with an inflating function may further comprise two abutting plates, and an accommodation space for inserting the air nozzle may be formed between the two abutting plates. An inner wall of the abutting plate may extend inwards along a radial direction of the accommodation space, forming a shoulder.

In another form thereof, the air nozzle may have an extension portion for inserting into the accommodation space, and a hook may be arranged on the extension portion. The air nozzle may move around its own axis between a first position and a second position. When the air nozzle is in the first position, the hook may separate from an inner wall of the second air outlet, and the air nozzle may translate along the axial direction within the second air outlet. When the air nozzle is in the second position, the hook may be connected to the inner wall of the second air outlet, and the air nozzle may be held in place within the second air outlet.

In another form thereof, the SPA air pump with an inflating function may further comprise two extension portions.

In another form thereof, the air nozzle may be formed with a threaded interface for connecting the air cavity of the inflatable product.

In another form thereof, the sealing valve core may protrude radially on a side of the abutting plate away from the air nozzle, forming a protruding edge. A sealing gasket may be arranged on the side of the protruding edge.

In another form thereof, when the sealing valve core is in the first position, the sealing gasket may adhere and seal the side wall at the connection between the air passage and the second air outlet.

In another form thereof, the elastic reset member may be a spring.

In another form thereof, the present disclosure provides a spa air pump with an inflating function comprising a housing, a sealing valve core and a nozzle. The housing may comprise an inlet defining a first air passageway, a first outlet defining a second air passageway in fluid communication with the first air passageway of the inlet, and a second outlet defining a third air passageway in selective fluid communication with the first air passageway of the inlet. The sealing valve core may be positioned between the inlet and the second outlet and may be configured to place the first air passageway of the inlet and the third air passageway of the second outlet in selective fluid communication. The nozzle may be positionable to interact with an interior portion of the second outlet to fluidly connect the third air passageway of the second outlet to an air cavity of the inflatable product.

In another form thereof, the present disclosure provides a spa air pump with an inflating function comprising a housing, a sealing valve core, and a nozzle. The housing may comprise an inlet defining a first air passageway, a first outlet defining a second air passageway in fluid communication with the first air passageway of the inlet and in fluid communication with a water cavity of the inflatable product, and a second outlet defining a third air passageway in selective fluid communication with the first air passageway of the inlet. The sealing valve core may be positioned between the inlet and the second outlet and may be configured to place the first air passageway of the inlet and the third air passageway of the second outlet in selective fluid communication in a first position and to seal the third air passageway from the first air passageway in a second position. The nozzle may be removably coupled to the second outlet to fluidly connect the third air passageway of the second outlet to an air cavity of the inflatable product, the second air passageway may remain in fluid communication with the water cavity of the inflatable product independent of the sealing valve being in the first position or the second position.

In another form thereof, the nozzle may include a lock member which may cooperate with a blocker of the second air outlet to couple the nozzle to the second air outlet.

In another form thereof, the nozzle may actuate the sealing valve from a first position wherein the third air passageway may be sealed from the first air passageway to a second position wherein the first air passageway of the inlet may be in fluid communication with the third air passageway of the second outlet.

In another form thereof, the nozzle may be rotatable within the second outlet to rotate from a first position to a second position.

In another form thereof, in the second position, the blocker of the second air outlet may cooperate with the lock member of the nozzle to hold the sealing valve core in an open position.

In another form thereof, a portion of the second outlet may carry a tab that extends from one side of the second outlet to a second side of the second outlet to define a plurality of openings through the second outlet.

In another form thereof, the nozzle may include an extension portion and a hook, the hook may be formed on the extension portion and may cooperate with the tab of the second air outlet to couple the nozzle to the second air outlet.

In another form thereof, the nozzle may be rotatably positioned within the second outlet to rotate from a first position to a second position.

In another form thereof, in the first position, the hook may extend through one of the plurality of openings and may be spaced apart from the tab such that the nozzle may be translatable within the second air outlet.

In another form thereof, in the second position, the hook may extend through one of the plurality of openings and may be positioned behind the tab such that the nozzle may be locked in place in the second outlet.

In another form thereof, the sealing valve core may comprise a shoulder, and an extension portion of the nozzle may contact the shoulder when the nozzle is inserted into the second air outlet to push the sealing valve core from a first position to a second position.

In another form thereof, the sealing valve core may comprise an elastic reset member that may bias the sealing valve core to the first position.

The present disclosure further provides a SPA swimming pool. An air pump may be arranged on the swimming pool, and the air pump may be the SPA air pump according to the present disclosure.

The present disclosure further provides an inflatable product. The inflatable product may comprise an internal wall, an external wall, and an air cavity at least partially defined by the internal wall and the external wall. The air cavity may be coupled to the second air outlet of the spa air pump according to embodiments of the present disclosure.

In another form thereof, the inflatable product may further comprise a conduit connecting the second air outlet to the air cavity.

In another form thereof, the conduit may be rigid.

In another form thereof, the conduit may be flexible.

Compared to the existing technology, various embodiments of the present disclosure may have the following beneficial effects:

Various embodiments disclosed herein may provide a SPA air pump with an inflation function. By setting a second air outlet on the SPA air pump and connecting the second outlet to the product to be inflated through an air nozzle, it is possible to inflate the product without the need for an additional air pump, which is more convenient. And during the installation of the air nozzle, the sealing valve core may be pushed to open, thereby connecting the second air outlet with the air inlet, thus achieving the connection of the air passage. After removing the air nozzle, the sealing valve core may be reset under the elastic resetting force and cut off the connection between the second air outlet and the air inlet again, avoiding air leakage. In addition, when the second air outlet is connected to the air inlet, the first air outlet and the air inlet may also be kept connected, so that when using the SPA air pump to inflate, the SPA massage function may still be used normally.

Additional features and advantages of the present disclosure will become apparent to those skilled in the art upon consideration of the following detailed description.

### BRIEF DESCRIPTION OF THE DRAWINGS

FIG. 1 is an exploded view of the SPA air pump according to an embodiment of the present disclosure;

FIG. 2 is another exploded view of the SPA air pump of FIG. 1;

FIG. 3 is a partial cross-sectional view of the SPA air pump of FIG. 1;

FIG. 4 is a partial cross-sectional view of the SPA air pump of FIG. 1;

FIG. 5 is a partial cross-sectional view of the SPA air pump of FIG. 1 depicting a sealing valve core in a closed position;

FIG. 6 is a partial cross-sectional view of the SPA air pump of FIG. 1 depicting the scaling valve core of FIG. 5 in an open position;

FIG. 7 is a top plan view of an inflatable spa including an air cavity and a water cavity.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure.

### DETAILED DESCRIPTION OF THE EMBODIMENTS

For the purposes of promoting an understanding of the principals of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. It will be understood that no limitation of the scope of the disclosure is thereby intended. The disclosure includes any alterations and further modifications in the illustrative devices and described methods and further applications of the principles of the disclosure which would normally occur to one skilled in the art to which the disclosure relates.

In the description of the present disclosure, it should be noted that the terms “up”, “down”, “inside”, “outside”, “top/bottom”, etc. indicate the orientation or position relationship based on the orientation or position relationship shown in the attached drawings, only for the convenience of describing the present disclosure and simplifying the description, rather than indicating or implying that the device or component referred to must have a specific orientation, or be constructed and operated in a specific orientation. Therefore, it cannot be understood as a limitation on the present disclosure. In addition, the terms “first” and “second” are only used to describe and cannot be understood as indicating or implying relative importance.

In the description of the present disclosure, it should be noted that unless otherwise specified and limited, the terms “installation”, “set with”, “set/connected”, “connected”, etc. should be understood broadly. For example, “connected” can be a wall mounted connection, a detachable connection, or an integrated connection, can be a mechanical connection, can be an electrical connection, can be directly connected, or can be indirectly connected through an intermediate medium, can be the internal connection between two components, and for ordinary technical personnel in this field, the specific meaning of the above terms in the present disclosure can be understood in a specific situation.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

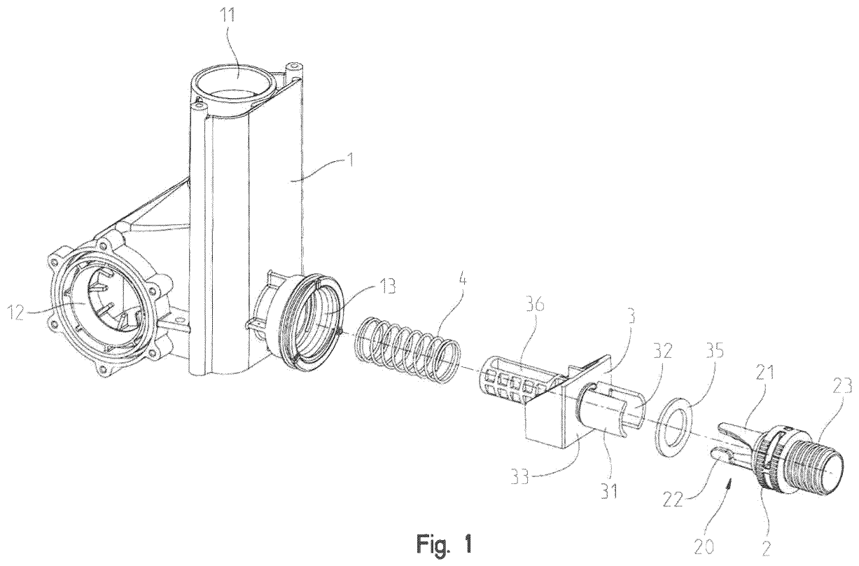

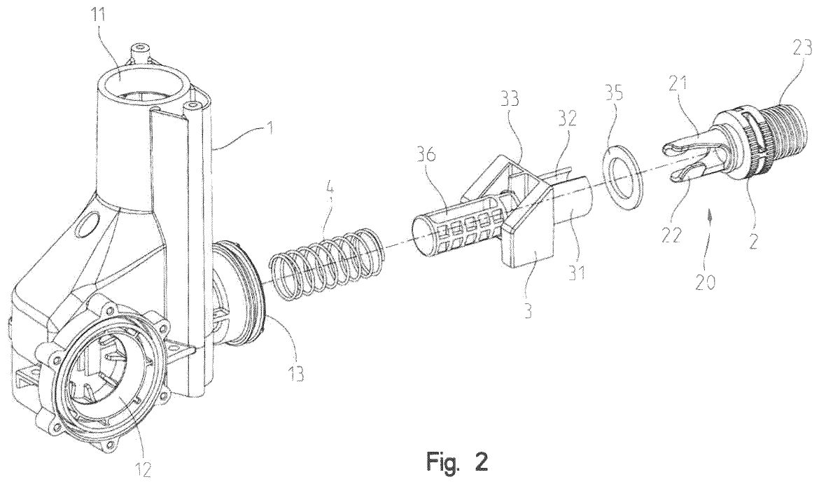

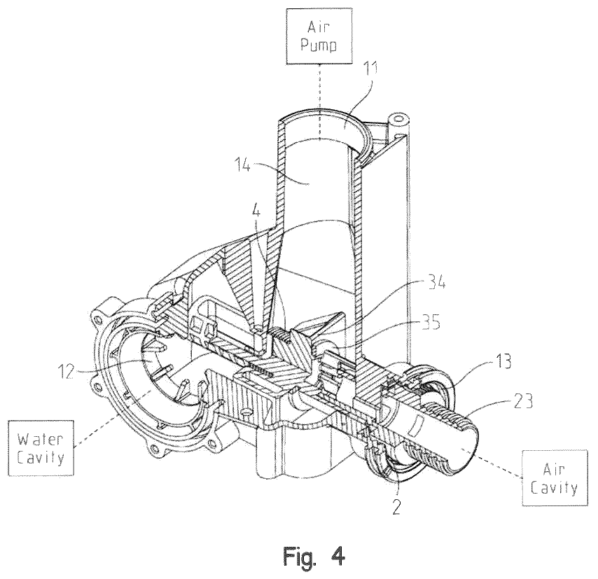

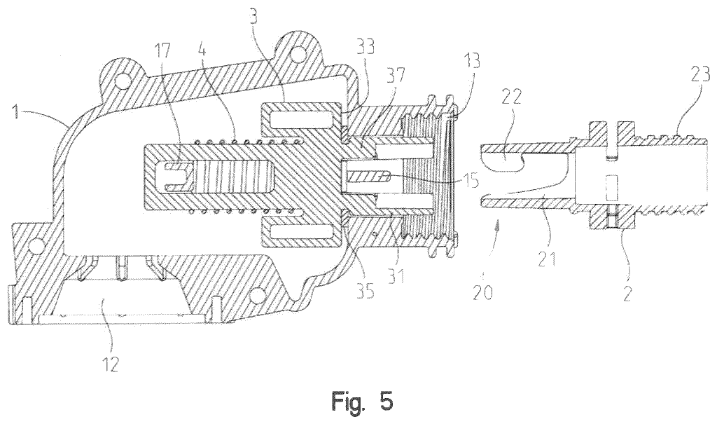

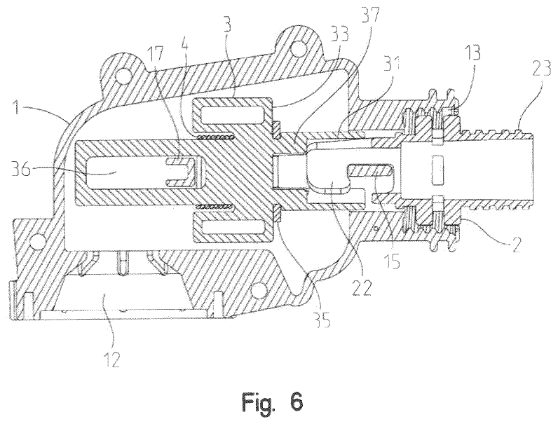

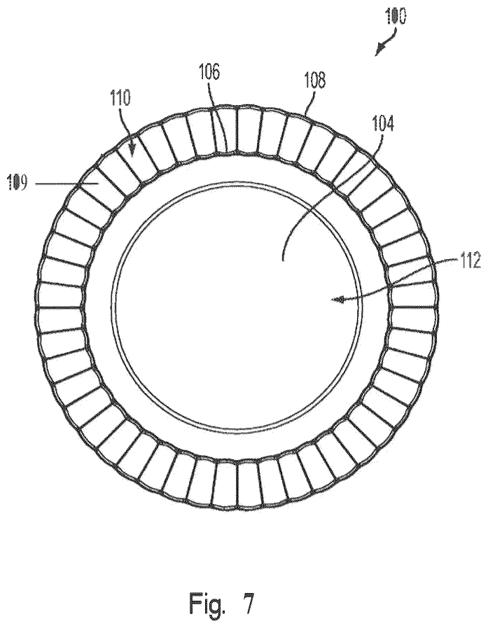

As shown in FIGS. 1 to 6, the present disclosure provides a SPA air pump with an inflating function. The SPA air pump with an inflating function may comprise a housing 1 and an air nozzle 2. The housing may be a monolithically formed structure or formed from multiple parts. The housing 1 comprises an air inlet 11, a first air outlet 12 connected to a water cavity of an inflatable product, such as a swimming pool, and a second air outlet 13 for inflating an air cavity of the inflatable product. In embodiments, second air outlet 13 may connect to the air cavity of the inflatable product through a conduit. The conduit may be flexible or rigid. FIG. 7 depicts an exemplary inflatable product 100. Inflatable product 100 is an inflatable swimming pool that includes a bottom wall 104, an internal side wall 106, and an external side wall 108. Internal side wall 106 and external side wall cooperate to define an air cavity 110. In embodiments, internal side wall 106 and external side wall 108 cooperate with bottom wall 104 and a top wall 109 to define air cavity 110. Internal side wall 106 and bottom wall 104 cooperate to define a water cavity 112. An internal piping structure may be provided in the air cavity 110. The internal piping structure may include nozzles that terminate in the water cavity, and the first air outlet 12 may be in fluid communication with the internal piping structure to provide massage bubbles to the water cavity through the internal piping structure and nozzles.

In embodiments, air nozzle 2 may carry a locking member 20 which cooperates with an inner wall of the second air outlet 13 to secure the air nozzle 2 in place within the second air outlet 13. In the illustrated embodiment, the inner wall of the second air outlet 13 is a blocker 15. Exemplary blockers include tabs and other suitable shapes to limit movement. In the illustrated embodiment, locking member 20 includes a hook 22 formed on an extension portion 21 of the air nozzle 2. The locking member 20 is rotatable from a first unlocked position relative to the second air outlet to a second locked position relative to the second air outlet. In the unlocked position, the air nozzle 2 is removeable from the second air outlet 13. In the locked position, the air nozzle 2 is secured to the air outlet 13. Other arrangements of exemplary lock members 20 and blockers 15 may be used to secure air nozzle 2 to second air outlet 13.

In embodiments, the blocker 15 may extend from a first side of the second air outlet 13 to a second side of the second air outlet 13. For example, a portion of the second air outlet 13 may include a blocker 15 that extends substantially vertically within a portion of the second air outlet 13 to create two openings through a portion of the second air outlet 13. In embodiments, blocker 15 may extend horizontally within a portion of the second air outlet or at an angle between horizontal and vertical.

The housing 1 is equipped with an air passage 14. The first air outlet 12 is connected to the air passage 14, and the connection between the second air outlet 13 and the air passage 14 is provided with a movable sealing valve core 3. The sealing valve core 3 is connected to an elastic reset member 4 to bias the sealing valve core 3 to a first position in which the second air outlet 13 and the air passage 14 are sealed. As depicted in FIGS. 1, 2, 5, and 6, sealing valve core 3 may be formed with a channel 36. Channel 36 may receive stop 17, which serves to limit the translational movement of sealing valve core 3.

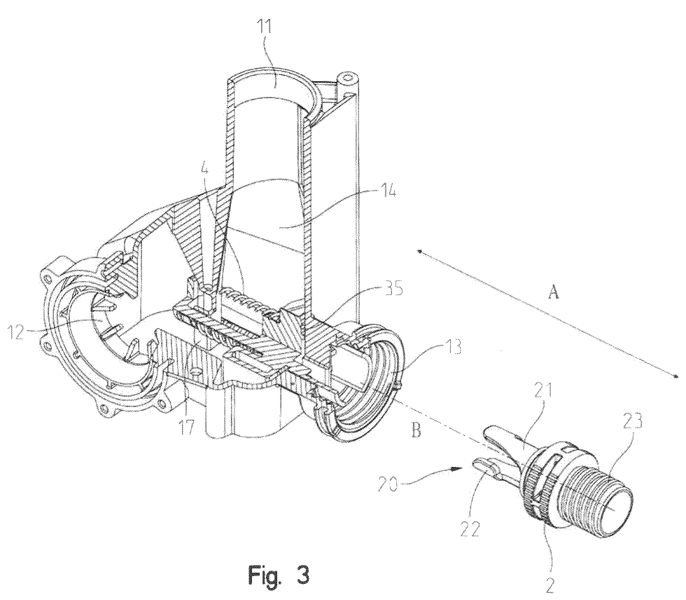

The air nozzle 2 is used to connect the sealing valve core 3 and the product to be inflated or deflated. The air nozzle 2 pushes the sealing valve core 3 to a second position in which the second air outlet 13 and the air passage 14 are connected, thus fluidly connecting the air inlet 11, the second air outlet 13, and the air cavity of the inflatable product. As indicated in FIG. 3, translational movement in a direction indicated by arrow A pushes the sealing valve core 3 to the second position. As the air nozzle 2 pushes the sealing valve core 3 to the second position against the biasing force of elastic reset member 4, the elastic reset member 4 accumulates an elastic reset force.

As stated, the SPA air pump with an inflating function is equipped with a second air outlet 13. The second air outlet 13 may connect to the air cavity 110 of the inflatable product through the air nozzle 2. This allows for inflation of the inflatable product without the need for an additional air pump, which is more convenient.

As discussed above and explained further below, when air nozzle 2 is inserted into second air outlet 13, the sealing valve core 3 is pushed to open to the second position, thereby connecting the second air outlet 13 with the air inlet 11 through air passage 14. After removing the air nozzle 2, the sealing valve core 3 will reset under the elastic resetting force accumulated in elastic reset member 4 and cut off the fluid connection between the second air outlet 13 and the air inlet 11 again, thus avoiding air leakage. In addition, when the second air outlet 13 is connected to the air inlet 11, the first air outlet 12 and the air inlet 11 remain connected. Thus, when using the SPA air pump to inflate, the SPA massage function can still be used normally.

To achieve the movement of the sealing valve core 3 to the second position by the air nozzle 2, the side of the sealing valve core 3 facing the air nozzle 2 has an abutting plate 31 extending towards the direction of the air nozzle 2. The abutting plate 31 is used to form a connection with the air nozzle 2. There may be two abutting plates 31, and an accommodating space 32 is formed between the two abutting plates 31 for the insertion of the air nozzle 2. The inner wall of the abutting plate 31 extends radially inward to form a shoulder 37. After being inserted into the accommodation space 32, the air nozzle 2 contacts the shoulder 37, thereby pushing the sealing valve core 3 to move.

The air nozzle 2 has a locking member 20 which includes an extension portion 21 for inserting into the accommodation space 32. There may be two extension portions 21 corresponding to the two abutting plates 31. The extension portion 21 is provided with a hook 22. When the extension portion 21 of the air nozzle 2 is inserted into the accommodation space 32, the extension portion 21 of the air nozzle 2 contacts the shoulder 37 thereby pushing the abutting plate 31 inward to the second position, placing second air outlet 13 and air inlet 11 in communication via air passage 14.

When the air nozzle 2 is inserted into the second air outlet 13, the hook 22 of the air nozzle 2 extends beyond the blocker 15 formed in the second air outlet 13. The air nozzle 2 moves around its own axis, axis B as depicted in FIG. 3, between a first position, which may be an unlocked position, and a second position, which may be a locked position. When the air nozzle 2 is in the first position, the hook 22 is not positioned behind the blocker 15, and the air nozzle 2 can be removed from the second air outlet 13, and the sealing valve core 3 can close under the elastic restoring force of the elastic reset member 4. When the air nozzle 2 is in the second position, the hook 22 is positioned behind the blocker 15, locking the air nozzle 2 in place, and fixing the sealing valve core 3 in an open position against the biasing force of the elastic reset member 4. Thus, the air nozzle 2 relies on two degrees of freedom to lock the air nozzle 2 in place: a translational degree of freedom as indicated by arrow A in FIG. 3, and a rotational degree of freedom about axis B in FIG. 3.

To connect the SPA air pump with an inflating function to the air cavity of the inflatable product, the air nozzle 2 is formed with a threaded interface 23.

To seal the second air outlet 13 and air passage 14 when the sealing valve core 3 is in the first position, the sealing valve core 3 protrudes radially to form an abutting surface 33 having a protruding edge 34 on the side of the butting plate 31 away from the air nozzle 2. A sealing gasket 35 is arranged on the side of the protruding edge 34. When the sealing valve core 3 is in the first position, the sealing gasket 35 seals the side wall of the connection between the air passage 14 and the second air outlet 13. The abutting surface 33 distributes the force generated by the spring across the sealing gasket 35 to effect a seal of the second air outlet 13.

The elastic reset member 4 may be a spring. Alternatively, the elastic reset member can be replaced with other parts that can generate elastic reset force.

The present disclosure further provides a SPA swimming pool, which comprises a swimming pool and an air pump arranged on the swimming pool, the air pump being the SPA air pump with an inflating function as described above.

### EXAMPLES

Example 1: A SPA air pump with an inflating function may comprise a housing and an air nozzle. The housing may comprise an air inlet, a first air outlet configured to be connected to a water cavity of an inflatable product, a second air outlet configured to inflate an air cavity of the inflatable product, and an air passage. The first air outlet may be connected to the air passage, and a connection between the second air outlet and the air passage may be provided with a movable sealing valve core. The sealing valve core may abut against an elastic reset member to set the sealing valve core at a first position in which the second air outlet and the air passage are sealed. The air nozzle may be configured to connect the sealing valve core and the air cavity of the inflatable product. The air nozzle may be further configured to push the sealing valve core to a second position in which the second air outlet and the air passage are connected, and to cause the sealing valve core to compress the elastic reset member to accumulate an elastic reset force.

Example 2: The SPA air pump with inflating function according to Example 1, wherein a side of the sealing valve core facing the air nozzle may have an abutting plate extending towards the air nozzle, and the abutting plate may form a connection with the air nozzle.

Example 3: The SPA air pump with inflating function according to Example 2 may further comprise two abutting plates. An accommodation space for inserting the air nozzle may be formed between the two abutting plates. An inner wall of the abutting plate may extend inward along a radial direction of the accommodation space. The inner wall may form a shoulder.

Example 4: The SPA air pump with inflating function according to Example 3, wherein the air nozzle may have an extension portion for inserting into the accommodation space, and a hook may be arranged on the extension portion. The air nozzle may move around its own axis between a first position and a second position. When the air nozzle is in the first position, the hook may separate from the inner wall of the second air inlet, and the air nozzle and the sealing valve core may translate within the second air outlet. When the air nozzle is in the second position, the hook may be connected to the inner wall of the second air outlet, and the air nozzle may be held in place within the second air outlet.

Example 5: The SPA air pump with inflating function according to Example 4 may further comprise two extension portions.

Example 6: The SPA air pump with inflating function according to Example 5, wherein the air nozzle may be formed with a threaded interface for connecting to the air cavity of the inflatable product.

Example 7: The SPA air pump with inflating function according to Example 6, wherein the sealing valve core may protrude radially on a side of the abutting plate away from the air nozzle, forming a protruding edge. A sealing gasket may be arranged on the side of the protruding edge.

Example 8: The SPA air pump with inflating function according to Example 7, wherein when the sealing valve core is in the first position, the sealing gasket may adhere and seal the side wall at the connection between the air passage and the second air outlet.

Example 9: The SPA air pump with inflating function according to Examples 1-8, wherein the elastic reset member may be a spring.

Example 10: The SPA air pump with inflating function according to Examples 1-9 may further comprise a swimming pool and an air pump arranged on the swimming pool. The air pump may be the SPA air pump with inflating function according to any one of Examples 1-9.

Example 11: A spa air pump with an inflating function may comprise a housing, a sealing valve core and a nozzle. The housing may comprise an inlet defining a first air passageway, a first outlet defining a second air passageway in fluid communication with the first air passageway of the inlet, and a second outlet defining a third air passageway in selective fluid communication with the first air passageway of the inlet. The sealing valve core may be positioned between the inlet and the second outlet and may be configured to place the first air passageway of the inlet and the third air passageway of the second outlet in selective fluid communication. The nozzle may be positionable to interact with an interior portion of the second outlet to fluidly connect the third air passageway of the second outlet to an air cavity of the inflatable product.

Example 12: A spa air pump with an inflating function may comprise a housing, a sealing valve core, and a nozzle. The housing may comprise an inlet defining a first air passageway, a first outlet defining a second air passageway in fluid communication with the first air passageway of the inlet and in fluid communication with a water cavity of the inflatable product, and a second outlet defining a third air passageway in selective fluid communication with the first air passageway of the inlet. The sealing valve core may be positioned between the inlet and the second outlet and may be configured to place the first air passageway of the inlet and the third air passageway of the second outlet in selective fluid communication in a first position and to seal the third air passageway from the first air passageway in a second position. The nozzle may be removably coupled to the second outlet to fluidly connect the third air passageway of the second outlet to an air cavity of the inflatable product, the second air passageway may remain in fluid communication with the water cavity of the inflatable product independent of the sealing valve being in the first position or the second position.

Example 13: The spa air pump according to any one of Examples 11 and 12, wherein the nozzle may include a lock member which may cooperate with a blocker of the second air outlet to couple the nozzle to the second air outlet.

Example 14: The spa air pump according to Example 13, wherein the nozzle may actuate the sealing valve from a first position wherein the third air passageway may be sealed from the first air passageway to a second position wherein the first air passageway of the inlet may be in fluid communication with the third air passageway of the second outlet.

Example 15: The spa air pump according to Example 14, wherein the nozzle may be rotatable within the second outlet to rotate from a first position to a second position.

Example 16: The spa air pump according to Example 14, wherein, in the second position, the blocker of the second air outlet may cooperate with the lock member of the nozzle to hold the sealing valve core in an open position.

Example 17: The spa air pump according to any one of Examples 11 and 12, wherein a portion of the second outlet may carry a tab that extends from one side of the second outlet to a second side of the second outlet to define a plurality of openings through the second outlet.

Example 18: The spa air pump according to Example 17, wherein the nozzle may include an extension portion and a hook, the hook may be formed on the extension portion and may cooperate with the tab of the second air outlet to couple the nozzle to the second air outlet.

Example 19: The spa air pump according to Example 18, wherein the nozzle may be rotatably positioned within the second outlet to rotate from a first position to a second position.

Example 20: The spa air pump according to Example 19, wherein, in the first position, the hook may extend through one of the plurality of openings and may be spaced apart from the tab such that the nozzle may be translatable within the second air outlet.

Example 21: The spa air pump according to Example 19, wherein, in the second position, the hook may extend through one of the plurality of openings and may be positioned behind the tab such that the nozzle may be locked in place in the second outlet.

Example 22: The spa air pump according to any one of Examples 11 and 12, wherein the sealing valve core may comprise a shoulder, and an extension portion of the nozzle may contact the shoulder when the nozzle is inserted into the second air outlet to push the sealing valve core from a first position to a second position.

Example 23: The spa air pump according to Example 22, wherein the sealing valve core may comprise an elastic reset member that may bias the sealing valve core to the first position.

Example 24: An inflatable product may comprise an internal wall, an external wall, and an air cavity at least partially defined by the internal wall and the external wall. The air cavity may be coupled to the second air outlet of the spa air pump according to any one of Examples 1-23.

Example 25: The inflatable product according to Example 24, may further comprise a conduit connecting the second air outlet to the air cavity.

Example 26: The inflatable product according to Example 25, wherein the conduit may be rigid.

Example 27: The inflatable product according to Example 25, wherein the conduit may be flexible.

It will be apparent to those skilled in the art that various modifications and variation can be made in the present disclosure without departing from the spirit or scope of the disclosure. Thus, it is intended that the present disclosure cover the modifications and variations of this disclosure provided they come within the scope of the appended claims and their equivalents.

1. A SPA air pump with an inflating function comprising:
a housing, and
an air nozzle, wherein the housing comprises an air inlet, a first air outlet configured to be connected to a water cavity of an inflatable product, a second air outlet configured to inflate an air cavity of the inflatable product, an air passage, the first air outlet is connected to the air passage, and a connection between the second air outlet and the air passage is provided with a movable sealing valve core, the sealing valve core abuts against an elastic reset member to set the sealing valve core at a first position in which the second air outlet and the air passage are sealed, and wherein the air nozzle is configured to connect the sealing valve core and the air cavity of the inflatable product, and is further configured to push the sealing valve core to a second position in which the second air outlet and the air passage are connected, and to cause the sealing valve core to compress the elastic reset member to accumulate an elastic reset force.

2. The SPA air pump with inflating function according to claim 1, wherein a side of the sealing valve core facing the air nozzle has an abutting plate extending towards the air nozzle, the abutting plate forming a connection with the air nozzle.

3. The SPA air pump with inflating function according to claim 2, further comprising two abutting plates, and an accommodation space for inserting the air nozzle is formed between the two abutting plates; an inner wall of the abutting plate extends inward along a radial direction of the accommodation space, forming a shoulder.

4. The SPA air pump with inflating function according to claim 3, wherein the air nozzle has an extension portion for inserting into the accommodation space, and a hook is arranged on the extension portion; the air nozzle moves around its own axis between a first position and a second position; when the air nozzle is in the first position, the hook separates from the inner wall of the second air outlet, and the air nozzle is translatable along the axial direction within the second air outlet; when the air nozzle is in the second position, the hook is connected to the inner wall of the second air outlet, and the air nozzle is held in place within the second air outlet.

5. The SPA air pump with inflating function according to claim 4, further comprising two extension portions.

6. The SPA air pump with inflating function according to claim 1, wherein the air nozzle is formed with a threaded interface for connecting to the air cavity of the inflatable product.

7. The SPA air pump with inflating function according to claim 2, wherein the sealing valve core protrudes radially on a side of the abutting plate away from the air nozzle, forming a protruding edge; a sealing gasket is arranged on the side of the protruding edge.

8. The SPA air pump with inflating function according to claim 7, wherein when the sealing valve core is in the first position, the sealing gasket adheres and seals the side wall at the connection between the air passage and the second air outlet.

9. The SPA air pump with inflating function according to claim 1, wherein the elastic reset member is a spring.

10. A SPA swimming pool, further comprising a swimming pool and an air pump arranged on the swimming pool, the air pump being the SPA air pump according to claim 1.

11. A SPA air pump for use with an inflatable product, comprising:
a housing comprising:
an inlet defining a first air passageway,
a first outlet defining a second air passageway in fluid communication with the first air passageway of the inlet, and
a second outlet defining a third air passageway in selective fluid communication with the first air passageway of the inlet;
a sealing valve core positioned between the inlet and the second outlet and configured to place the first air passageway of the inlet and the third air passageway of the second outlet in selective fluid communication, and
a nozzle positionable to interact with an interior portion of the second outlet to fluidly connect the third air passageway of the second outlet to an air cavity of the inflatable product.

12. A SPA air pump for use with an inflatable product, comprising:
a housing comprising:
an inlet defining a first air passageway,
a first outlet defining a second air passageway in fluid communication with the first air passageway of the inlet and in fluid communication with a water cavity of the inflatable product, and
a second outlet defining a third air passageway in selective fluid communication with the first air passageway of the inlet;
a sealing valve core positioned between the inlet and the second outlet and configured to place the first air passageway of the inlet and the third air passageway of the second outlet in selective fluid communication in a first position and to seal the third air passageway from the first air passageway in a second position, and
a nozzle removably coupled to the second outlet to fluidly connect the third air passageway of the second outlet to an air cavity of the inflatable product, the second air passageway remaining in fluid communication with the water cavity of the inflatable product independent of the sealing valve being in the first position or the second position, wherein the nozzle actuates the sealing valve from the second position to the first position.

13. The SPA air pump of claim 11, wherein the nozzle includes a lock member which cooperates with a blocker of the second air outlet to couple the nozzle to the second air outlet.

14. The SPA air pump of claim 13, wherein the nozzle actuates the sealing valve from a first position wherein the third air passageway is sealed from the first air passageway to a second position wherein the first air passageway of the inlet is in fluid communication with the third air passageway of the second outlet.

15. The SPA air pump with inflating function according to claim 14, wherein the nozzle is rotatable within the second outlet to rotate from a first position to a second position.

16. The SPA air pump of claim 14, wherein, in the second position, the blocker of the second air outlet cooperates with the lock member of the nozzle to hold the sealing valve core in an open position.

17. The SPA air pump of claim 11, wherein a portion of the second outlet carries a tab that extends from one side of the second outlet to a second side of the second outlet to define a plurality of openings through the second outlet.

18. The SPA air pump of claim 17, wherein the nozzle includes an extension portion and a hook, the hook formed on the extension portion and cooperating with the tab of the second air outlet to couple the nozzle to the second air outlet.

19. The SPA air pump of claim 18, wherein the nozzle is rotatably positioned within the second outlet to rotate from a first position to a second position.

20. The SPA air pump of claim 19, wherein, in the first position, the hook extends through one of the plurality of openings and is spaced apart from the tab such that the nozzle is translatable within the second air outlet.

21. The SPA air pump of claim 19, wherein, in the second position, the hook extends through one of the plurality of openings and is positioned behind the tab such that the nozzle is locked in place in the second outlet.

22. The SPA air pump of claim 11, wherein the sealing valve core comprises a shoulder, and an extension portion of the nozzle contacts the shoulder when the nozzle is inserted into the second air outlet to push the sealing valve core from a first position to a second position.

23. The SPA air pump of claim 22, wherein the sealing valve core comprises an elastic reset member that biases the sealing valve core to the first position.

24. An inflatable product comprising:
an internal wall,
an external wall,
an air cavity at least partially defined by the internal wall and the external wall, the air cavity coupled to the second air outlet of the SPA air pump of claim 1.

25. The inflatable product of claim 24, further comprising a conduit connecting the second air outlet to the air cavity.

26. The inflatable product of claim 25, wherein the conduit is rigid.

27. The inflatable product of claim 25, wherein the conduit is flexible.

28. The SPA air pump of claim 12, wherein the nozzle includes a lock member which cooperates with a blocker of the second air outlet to couple the nozzle to the second air outlet.

29. The SPA air pump with inflating function according to claim 12, wherein the nozzle is rotatable within the second outlet to rotate from a first position to a second position.

30. The SPA air pump of claim 28, wherein, in the second position, the blocker of the second air outlet cooperates with the lock member of the nozzle to hold the sealing valve core in an open position.

31. The SPA air pump of claim 12, wherein a portion of the second outlet carries a tab that extends from one side of the second outlet to a second side of the second outlet to define a plurality of openings through the second outlet.

32. The SPA air pump of claim 31, wherein the nozzle includes an extension portion and a hook, the hook formed on the extension portion and cooperating with the tab of the second air outlet to couple the nozzle to the second air outlet.

33. The SPA air pump of claim 32, wherein the nozzle is rotatably positioned within the second outlet to rotate from a first position to a second position.

34. The SPA air pump of claim 33, wherein, in the first position, the hook extends through one of the plurality of openings and is spaced apart from the tab such that the nozzle is translatable within the second air outlet.

35. The SPA air pump of claim 33, wherein, in the second position, the hook extends through one of the plurality of openings and is positioned behind the tab such that the nozzle is locked in place in the second outlet.

36. The SPA air pump of claim 12, wherein the sealing valve core comprises a shoulder, and an extension portion of the nozzle contacts the shoulder when the nozzle is inserted into the second air outlet to push the sealing valve core from a first position to a second position.

37. The SPA air pump of claim 36, wherein the sealing valve core comprises an elastic reset member that biases the sealing valve core to the first position.

38. An inflatable product comprising:
an internal wall,
an external wall,
an air cavity at least partially defined by the internal wall and the external wall, the air cavity coupled to the second air outlet of the SPA air pump of claim 11.

39. The inflatable product of claim 38, further comprising a conduit connecting the second air outlet to the air cavity.

40. The inflatable product of claim 39, wherein the conduit is rigid.

41. The inflatable product of claim 39, wherein the conduit is flexible.

42. An inflatable product comprising:
an internal wall,
an external wall,
an air cavity at least partially defined by the internal wall and the external wall, the air cavity coupled to the second air outlet of the SPA air pump of claim 12.

43. The inflatable product of claim 42, further comprising a conduit connecting the second air outlet to the air cavity.

44. The inflatable product of claim 43, wherein the conduit is rigid.

45. The inflatable product of claim 43, wherein the conduit is flexible.
